(19) United States
(12) Patent Application Publication
(10) Pub. No.: US 2020/0187688 A1
(43) Pub. Date: Jun. 18, 2020

(54) STIRRING DEVICE SYSTEM

(71) Applicants: Ravindra Kashyap, Brooklyn, NY (US); Govind Sahu, Brooklyn, NY (US)

(72) Inventors: Ravindra Kashyap, Brooklyn, NY (US); Govind Sahu, Brooklyn, NY (US)

(21) Appl. No.: 16/714,058

(22) Filed: Dec. 13, 2019

Related U.S. Application Data
(60) Provisional application No. 62/779,063, filed on Dec. 13, 2018.

(51) Int. Cl. A47G 19/16; B01F 1/00; B65D 85/808; A23P 10/10; A47J 31/20; A23L 2/60

(52) U.S. Cl. CPC A47G 19/16; B01F 1/0011; B65D 85/808; A23P 10/10; A47G 2019/125; A23L 2/60; B01F 2215/0014; A23V 2002/00; A47J 31/20

(57) ABSTRACT

The system includes a cup, a lid, a stir, and one or more bags. The cup is configured to hold fluids. The lid includes a top portion and a bottom portion configured to couple to and cover an open portion of the cup. The stir includes a knob, a longitudinal shaft, and a distal shaft extending outwardly from the longitudinal shaft. The knob is disposed on the top portion of the lid and coupled to the longitudinal shaft threaded through the bottom portion of the lid. The one or more bags are coupled along the length of the longitudinal shaft.

### CROSS-REFERENCE TO RELATED APPLICATIONS

The present application claims the benefit of and priority to U.S. Provisional Application Ser. No. 62/779,063, filed on Dec. 13, 2018. The entire content of the disclosure is incorporated herein by reference.

### FIELD

To create a disposable or non-disposable stirring system that contains chemicals or food material (like tea, sugar, spice, dried milk, in the form of a food wafer or a membranous porous bag containing the desired food substances) that will dissolve into a solvent (hot water) when immersed into solvents.

### BACKGROUND

There are any number of stirring devices out there in the market like magnetic mixers or other stirrer used in scientific laboratories, including centrifuges, motorized grinders and mixers, and so on, however, there is no device in the market that does the job of stirring a food substance like tea and, or, spice and, or, sugar, or any other food material is an efficient, cost-saving way by means of a compact design as illustrated in various embodiment.

### BACKGROUND

According to an aspect of the present disclosure, systems and methods are provided that address the above-mentioned needs. In an aspect of the present disclosure, a stirring system containing various dissolvable materials that will dissolve when immersed. The system includes a cup, a lid, a stir, and one or more bags. The cup is configured to hold fluids. The lid includes a top portion and a bottom portion configured to couple to and covers an open portion of the cup. The stir includes a knob, a longitudinal shaft, and a distal shaft extending outwardly from the longitudinal shaft. The knob is disposed on the top portion of the lid and coupled to the longitudinal shaft threaded through the bottom portion of the lid. The one or more bags are coupled along the length of the longitudinal shaft.

In another aspect of the present disclosure, the one or more bags may be membranous porous bag.

In another aspect of the present disclosure, the one or more bags may contain at least one of tea, food, and sugar.

In another aspect of the present disclosure, the longitudinal shaft and the distal shaft may be wood or metal.

In another aspect of the present disclosure, the lid may further include a serrated portion configured to provide an opening in the lid.

### BRIEF DESCRIPTION OF THE DRAWINGS

Various aspects and features of the present disclosure are described hereinbelow with references to the drawings, wherein:

FIG. 1 is a perspective view of a stirring system according to aspects of the disclosure;

FIG. 2 is a perspective view of an actuator and the stirring system according to aspects of the disclosure;

FIG. 3a is a perspective view of an actuator the actuator and a shaft according to aspects of the disclosure;

FIG. 3b is a perspective view of an actuator according to aspects of the disclosure;

FIG. 4 is a perspective view of another aspect of the stirring system according to aspects of the disclosure;

FIG. 5a is a perspective view of flat stick piece having slits according to aspects of the disclosure;

FIG. 5b is a perspective view of another aspect of the disclosure, having a spoon according to the disclosure;

FIG. 5c is a perspective view of another aspect of the disclosure, having a fork according to the disclosure;

FIG. 5d is a perspective view of another aspect of the disclosure, having a food bag according to the disclosure;

FIG. 6a is a perspective view of another aspect of the disclosure, having a circular disc-shaped configuration according to the disclosure;

FIG. 6b is a perspective view of another aspect of the disclosure, according to FIG. 6a;

FIG. 7a is a perspective view of another aspect of the disclosure, according to FIG. 6a;

FIG. 7b is a perspective view of another aspect of the disclosure, according to FIG. 1;

FIG. 8 is a perspective view of another aspect of the disclosure, according to FIG. 1;

FIG. 9 is a perspective view of another aspect of the disclosure, according to FIG. 1; and

FIG. 10 is a perspective view of another aspect of the disclosure, according to FIGS. 8 and 9.

### DETAILED DESCRIPTION

The stirring system may include a narrow stick or a spoon, or a fork or any other utensils or a plain tube or porous multi-hole tube, made from wood, metal, plastic or food substance itself, are combined and conjoined with a porous membranous bag containing food substances (or chemicals) or a wafer containing food substances (or chemicals) whose solutes contained therein are made to dissolve into any given solvent to make any desirable beverage or solution when the compact said stick or spoon or fork or any other utensil or tube or a porous multi-hole tube, are stirred inside the said solvent contained in a cup or a glass or a container. The stirring system can also be attached to an actuator like a motor or some reciprocating electromagnet apparatus or some solenoid actuators or some piezoelectric actuating devices, which will actuate, spin, rotate, and move the embodied stirring system and are made operational inside a cup or a container full of solvent to yield a desired solution mixture. Additional electromagnetic wave generators, (like UV light generator lamp and, or a radio wave generator, and, or, visible light wave generator, and, or, a microwave generator, and or, laser generator, and or, a sound wave generator like a speaker (which is connected to any electronic music or sound player devices) and, or a gas generator device which would be a pump (like a diaphragm pump), and or a solvent pump generator device which can individually or together be made a part of this stirring system. Such modifications provide ways of introducing solutes into any given solvent contained inside a cup or a container. By stirring and swirling the stirring system, the stirring system is an efficient solution mixture and creates a solution that is germ-free by the introduction of UV light for instance that kills microorganisms, or, that's' bombarded with light or sound energy to make a desired optically active molecular mixtures, or, that's' infused with gas or any other solvent to make for other desired solution mixture. In this embodiment of the stirring system an accurate amount of solute to be dissolved in a given amount of solvent to make a desirable beverage can be accomplished. Many different shapes and sizes of the stirring system can be construed to serve different ways that a beverage or consumable desirable drink is to be made or a chemical solutions or a biochemical solutions are to be manufactured. Not limited to human and animal consumption for making food and drinks, but also it can be applied to mix different solute and solvent in any chemical process, or a biochemical process, or mixing biological entities like microorganism in a solution, or in other industrial and scientific process where mixing of solutes and solvent are necessary to create a certain solution mixture. Thus there are numerous ways that this device can be used in mixing substances like food, drink, chemical, biochemical, biological tissues, and, or microorganism, to yield a desirable solution mixture.

The stirring system that takes any given solutes and mixes it with any given solvents to create desirable solutions. A thin piece of stick made from wood or metal (like steel or iron) or plastic or a solid food material, are embedded, packed, glued, or tied, with a wafer containing a single or multiple layers of food (or any other chemical, biochemical substances), or a porous membranous bag containing food material, like tea, coffee, sugar, spice, salt (or any other chemical, biochemical substances) which can be placed and stirred inside a solvent (like hot water) containing container or cup. The stirring system is stirred when immersed inside a solvent containing cup or container either manually or by an actuator, (motor, piezoelectric actuators, reciprocating electromagnets, or solenoidal actuators), such that the solutes contained in the said porous bag or wafer (that contains food, chemicals or biochemical substances) attached to the said stick will dissolve into the said solvent to yield the desired solution mixture. Into this stirred solution mixture different kinds of electromagnetic waves like (Ultraviolet light, Visible light, Radio waves, Microwaves, Heatwaves, etc.), sound waves, gas particles, or other solvents can be added by electromagnetic wave generators, sound wave generators, gas pumps, solvent pumps, respectively, to yield another set of preferred solutions. Thus the stirring system is done to create the desired solution mixtures possible.

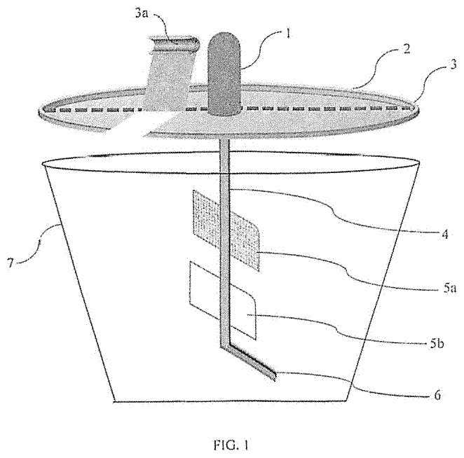

FIG. 1 discloses the stirring system, wherein a wooden stick or a metal piece or a plastic piece or a piece made from solid food material, is attached to a food wafer or porous membranous food bag. On top of the said, the wooden piece or the metal piece or the plastic piece or the piece made from solid food material is an affixed cap or a lid, which in turn is attached to a handle knob.

FIG. 1 discloses two small pieces of elongated L shaped wooden sticks, 4, 6, (these sticks could be made from any other material like metal, plastic, paper, plant material, solid food items/material, stone), and that are glued and stuck together. In between these two thin glued wooden pieces, 4, 6, are a food containing porous membranous bag like a tea bag or a food wafer, 5a, and a porous membranous bag containing sugar or another food wafer, 5b, FIG. 1. The membranous porous bag containing food, or food bag or solid food wafer entity contains a specified calibrated amount of food material (or chemical material or biochemical) that will dissolve into a specified calibrated amount of solvent to make an accurate desirable solution mixture devoid of less or more, improper and inaccurate solute-solvent mixture. The conjoined stick, 4, 6, are attached to a knob holder, 1, on top, and both, 1, and 4, 6, are attached to the cup cap or container cap lid, 3, FIG. 1. Collectively, 1, 4, 5a, 5b, 6, so constructed are designated as stirring system, FIG.1. The cap, 3, can be folded in half (or in multiple other ways) as indicated by the dashed black line running across the lid cap, 3, FIG. 1, to make the stirring system into a compact design. The stirring system can be placed in a cup, 7, where a solvent like hot water is poured in. The cap knob holder, 1, would be used by one's fingers to twist, turn, spin and rotate the configured stirring system to allow for instance the tea wafer or tea bag, 5a, and the sugar wafer or sugar bag, 5b, solutes to dissolve its ingredients into the hot water solvent. The food bag can be a porous membranous bag like a conventional filter paper bag which contains edible food items (or any other substance) inside itself, such as a common tea bags available in the market. Thereafter the lid cap, 3, safely is closed on top of the cup, 7, leaving the food bag or food wafer, 5a, and 5b, inside the cup, 7, and immersed in hot water solvent within the cup. Then the partial partition, 3a, of the lid cap, 3, can be opened through which that person can drink to consume the desired dissolved tea and sugar and hot water beverage solution mixture. The stirring system puts together tea, sugar, and a stirring system altogether in a compact design, making it a little time saving, efficient and convenient device for a person to use when it comes to consuming a hot beverage like tea or coffee and or sugar and or spice solution mixture.

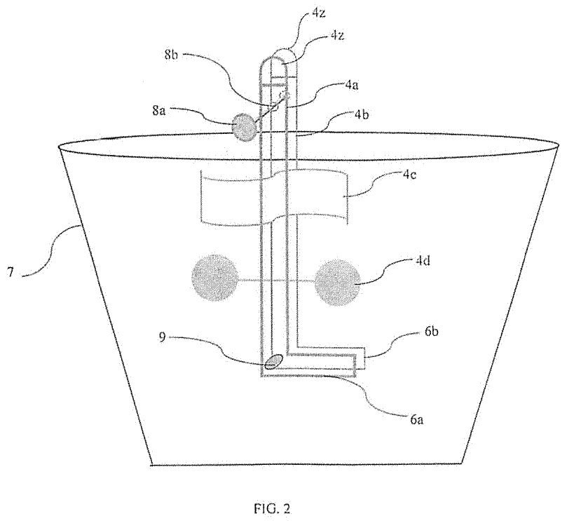

FIG. 2 discloses two metal (steel or iron) or wood or plastic or solid food material pieces in an L shaped stick configuration which are adhered to the two L shaped pieces together with a ribbon of food wafer or ribbon of porous food bag or a spherical shaped food wafer or a spherical shaped porous food bag to be jammed in between the said L shaped pieces.

FIG. 2, shows two metal pieces 4a, 4b, that entrap two food wafers and or food bags, 4c, 4d, that have dissolvable solutes in them, and are of different shapes and sizes, like, 4c, is a ribbon shape food wafer or porous bag containing food, and 4d is a spherical shaped food wafer or porous bag containing food. The L shaped pieces made of wood or metals (or any other material), 4a, and, 4b, are movable or rotatable with respect to each other as they are attached at one end with an affixed non-threaded screw, 9, (with small nuts on either side) going through an aligned common hole between the two arms of the L shaped pieces, 4a, 4b, FIG. 2. On the other end of, 4a, a screw, 8a, articulates with the common aligned hole, 8b, and goes through, 4a, into the screw hole of, 4b, FIG. 2. By screwing into, 8b, the screw, 8a, goes into piece, 4b, from piece, 4a, and causes the pieces 4a, and, 4b, to come extremely close together thereby trapping the food containing porous bag or food wafer, 4c, 4d, like tea wafer, 4c, or sugar wafer, 4d, in between the L shaped metal pieces, 4a, 4b, FIG. 2. Besides tea or sugar, these food wafers or food bags may contain coffee, spices, honey, salt, dried solid milk, or any other food items, including medicines or chemicals or biochemical. Actually, a variation of the disclosure shown in FIG. 1 is embodied in the disclosure illustrated in FIG. 2, wherein the stirring system further comprises, 4z, 4a, 4b, 4c, 4d, 6a, 6b, 9, 8a, 8b, together. Then this stirring system is immersed in a cup, 7, filled with hot water solvent and twisted, swirled and rotated by holding on to the knob holder, 4z, by a user's fingers, to allow the solutes of the food material in 4c, 4d, to dissolve into the hot water solvent or any other solvent contained within the cup, 7, FIG. 2. Once the stirring system has been used, the screw, 8a, can be unscrewed, and the remaining food bag or food wafer, 4c, 4d, can be thrown away and discarded. Thus, in FIG. 2, the stirring system is non-disposable, with the exception of the food bag or food wafer, 4c, 4d, and reusable compared to the stirring system in FIG. 1 which is disposable after use. Nevertheless, the stirring system of FIG. 2 can be made disposable too. The screw mechanisms, 8a, 9, can be substituted with many varieties of mechanism and methods to hold the L shaped metal or wood or plastic pieces, 4a, 4b, together, and those mechanisms include latch systems, or pins' system, or system of tying with threads, etc. Although the two pieces of thin L shaped metal pieces, 4a, 4b, are shown, there could be three or four or any number of these thin metal plates constructed together, with any number of food wafers, or food bags, in between them to comprise another new stirring system.

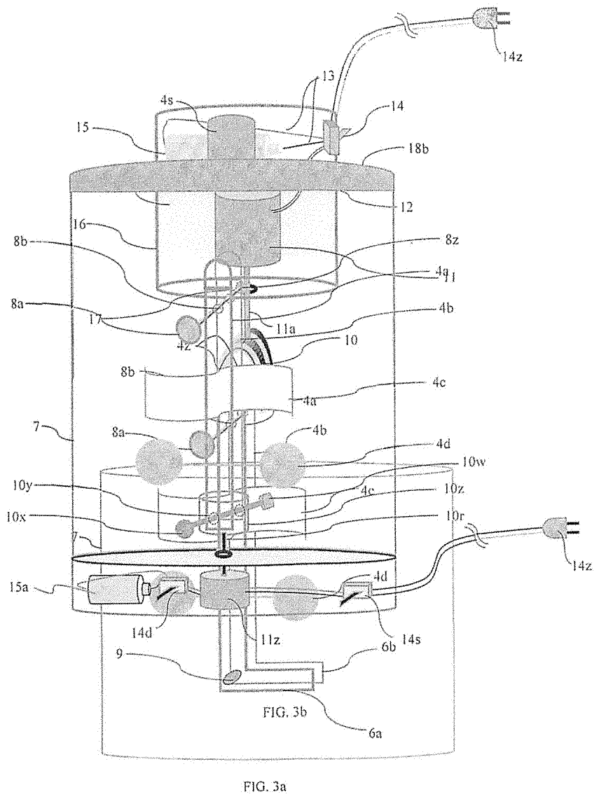

FIG. 3a discloses an actuator and shaft attached to an exemplary inverted cup, holder entity, or gripper entity piece that articulates and grips the system of FIG. 2, causing rotational spinning motion of the system. Also shown is the power source like a battery that powers the actuator which in this case is a motor. FIG. 3a, builds upon FIG. 2, wherein an actuator articulates with the top portion of the stirring system in FIG. 2. The knob holder, 4z, is made to articulate or be affixed to a right size and shape inverted cup, 10, FIG. 3a. The inverted cup, 10, is affixed to a motor shaft, 11a, of the motor, 11, FIG. 3a. The motor, 11, is secured inside an encasing, 16, and held together fastidiously by the motor stabilizers 18a, 18b, FIG. 3a. The motor shaft, 11a, is stabilized by the bearings, 17, FIG. 3. The motor wires, 12, are wired into a switch and its box, 14, FIG. 3a. The switch, 14, is connected via wires, 13, to a battery, 15, or to an outlet power source, 14z, FIG. 3a. The switch box, 14, may contain electronics and, or transformer, to transfer energy in the form of electricity to the motor, 11, FIG. 3a. The electronics in the switch box, 14, may allow the motor, 11, to be operational for certain amount of time and then the power will be cut off going into the motor, 11, until the switch, 14, is turned “on” again for the next operational use of the motor, 11. Again, when the switch, 14, is turned on, electricity will flow from the battery, 15, or the outlet, 14z, into the motor, 11, via the switch and the switch box, 14, FIG. 3a. The motor, 11, will spin its shaft, Ila, which will rotate and spin the cup, 10, which in turn will rotate and spin the knob holder, 4z, as 10, 4z, articulate with each other, although they can be in an affixed to each other, FIG. 3a. Thusly, the entire stirring system of FIG. 3, will spin and rotate. When the food wafers or porous food bags, 4c, 4d, are rotating and spinning with the spinning stirring system inside a cup or container, 7, that contains solvents' especially hot water then the solutes of the food wafers and or food bags, 4c, 4d, will begin to dissolve into the solvent or the hot water contained within the cup, 7, FIG. 3a, in a robust homogeneous way, rendering a well-mixed solution mixture for consumption.

FIG. 3b discloses an actuator like a motor (could be a piezoelectric crystals actuator apparatus or an electromagnet actuator apparatus) placed in the solvent-proof bottom chamber of a container and made to actuate via the power source from a battery or an outlet when a switch is turned on, articulating the system in a closed solute, solvent environment of the container to yield a desired homogeneous calibrated solution mixture.

FIG. 3b shows a different variation of the stirring system design from FIG. 3a, wherein the actuator, a motor, 11z, (although the motor actuator can be replaced with a system of electromagnet actuator system or a piezoelectric crystal actuator system), placed inside a solvent-proof bottom chamber of the container or cup, 7, FIG. 3b. The actuator, a motor, 11z, is powered by a battery, 15a, through a switch system, 14d, or, from the plug in wall outlet system through a switch system, 14z, FIG. 3b. The shaft of the actuator, 10r, goes through the solvent or waterproof bearing hole on the roof of the solvent-proof chamber, FIG. 3b. The actuator shaft, 10r, is affixed to a cylindrical cup like holder entity, 10z, FIG. 3b. On this holder entity, 10z, there are side holes, 10y, through which a screw or a pin, 10x, traverses and enters into aligned holes on 4a, and, 4b, to exit out of another hole on another side of the cylindrical cup holder entity, 10z, FIG. 3b. The screw or the pin entity, 10x, is secured with a screw cap, 10w, at the other end of the said screw or pin entity, 10x, FIG. 3b. The fastening of the stirring system comprising of, 4a, 4b, 4c, 4d, 8a, 8b, to the cylindrical holder 10z, via the screw or pin, 10x, 10w, allows for non-disarticulation, and non-dismemberment of the stirring system especially during the spinning and rotating phase of the said, stirring system, FIG. 3b. On top of the container or cup, 7, there a screw type cup lid, 4s, that not surprisingly screws onto the top of the container, 7, in order to prevent solution mixture from splashing out of the container, 7, when this stirring system configuration is operational, FIG. 3b. To make a desired solution mixture the stirring system (again comprising of 4a, 4b, 8a, 8b, 4c (being the food bag, or food wafer entity), 4d (being the food bag, or food wafer entity)) are secured onto a holder entity, 10z, via screw/pin/cap entity 10x, 10w, FIG. 3b. Then hot or cold solvent is poured into the container, 7, the screw lid, 4s, is closed on top of the container, 7, FIG. 3b. Electrical power from the battery, 15a, or outlet, 14z, is provided to the actuator motor, 11z, when the switch, 14d, or 14s, is turned “on,” FIG. 3b. The actuator motor, 11z, rotates the shaft, 10r, which rotates the holder entity, 10z, 10x, 10w, and the stirring system, 4a, 4b, 8a, 8b, 8z, 4c, 4d, FIG. 3b. Thus the solutes contained in the food bag or food wafer 4c, 4d, are spun, causing the dissolution of theses solutes into the solvent contained in the container, 7, FIG. 3b. After a period of time, when the desired solution mixture is created, then the switch, 14s, or 14d is turned “off,” shutting down the mixing process. Then the screw lid, 4s, is unscrewed and the newly created desired liquid solution mixture is poured into another container for consumption or other uses. The stirring system can be discarded and made disposable and a new one placed for the entire process to be repeated again to make another batch of desired solutions, FIG. 3b.

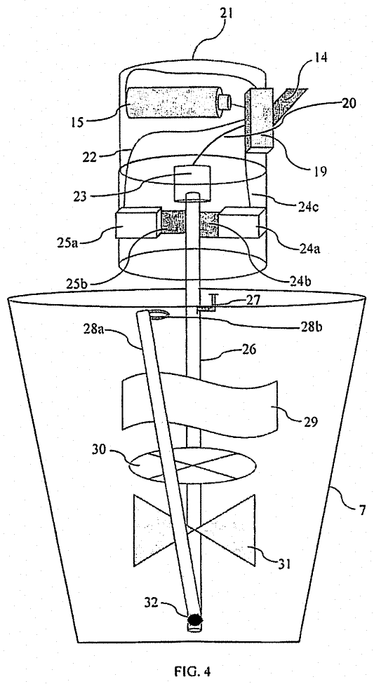

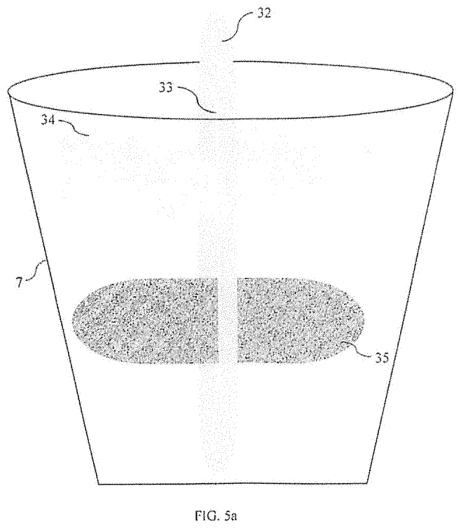

FIG. 4 discloses two articulating and conjoined sticks (cylindrical, rectangular, or any other shape), are actuated by an affixed set of piezoelectric crystal actuator system (many such systems exist in the market today) and, or, a reciprocating electromagnet system and or solenoids system, in the x, y, and z-direction. The distal end of the two stick system is attached to each other by a screw system or a pin system. The proximal end of the two stick system articulates and joins each other through a ring and hook mechanism to bring closer together the two sticks. The bringing together of the two sticks entraps and jams the food wafers or porous food bags in between the said two sticks. Then an energy source like a battery electrically powers an actuator like a piezoelectric crystal actuator system or a reciprocating electromagnet system or a solenoid system. Moreover, multiple sticks can be attached or affixed to the actuator in a parallel or series fashion. In equal measure, two or more or multiple food wafers or porous food bags can be jammed or glued in between the two or more stick systems.

FIG. 4, depicts another variation of the stirring system wherein there are two pieces of thin cylindrical elongated metal rods, 28a, and 26, affixed to each other through a non-threaded screw bolt, 32, with nuts on either end, 32, that also allow, 28a, and, 26, to rotate past each other in clockwise or counterclockwise direction. The rod pieces, 28a and 26, can be made from any material including metal (steel, iron, copper, aluminum) or wood or plastic or event solid food substances or solid chemical or solid biochemical substances. In between the articulating rods 28a and 26, there are different shape and sizes food bags or solid food wafers, 29, 30, 31, whose solutes can readily dissolve into a solvent if this configuration of the stirring system is placed in a cup, 7, and swirled and stirred with aforesaid solvent in it. The food bags, 29, 30, 31, can be a filter paper bag with food inside it like tea, coffee, sugar, spices, 29, 30, 32, and come in all different shapes and sizes. The food wafers have similar designations, 29, 30, 31, and may or may not be contained inside a porous membranous bags. In order to secure and fasten these food bags, or food wafers, 29, 30, 31, in place with the articulating thin cylindrical rod pieces, 28a, and 26, fasten the proximal end ring, 28b, affixed to rod piece, 28a, onto and over a ring holder, 27, that's affixed to rod piece, 26, FIG. 4. Once the rod pieces, 28a, and 26 are fastened tightly to each other by a ring, 28a, that's made to go over the ring holder, 27, the frictional forces between the food wafers or food bags, 29, 30, 31, and the rod pieces, 28a, 26, will be substantial such as to hold the food wafers, or food bags, 29, 30, 31, stably between the rods, 28a, and 26, thus preventing dislodgement of the food bags, and, or, food wafer, 29, 30, 31, especially when rotational and spinning motion is at play for the rods, 28a, 26, FIG. 4. Note there are many ways like using conventional means of hook systems, pin systems, screw systems, latch systems to fasten rod pieces 28a, to, 27, to join to each other, not just by ring and ring holder, 28a, 27, means illustrated in FIG. 4. Notice that main thin rod piece, 26, is attached to the piezoelectric actuators, 23, 24a, 24b, 25a, 25b, in the x, y and z directions, and 23, 24a, 24b, 25a, 25b, in x, y and z directions, FIG. 4, could also represent reciprocating electromagnets and or solenoidal. The piezoelectric actuators (or reciprocating electromagnets, or solenoids), 23, 24a, 24b, 25a, 25b, are affixed on one end to the encasing, 21, for stabilization and the other end to the rod piece, 26, FIG. 4. The piezoelectric actuators (or reciprocating electromagnets, or solenoids), 23, 24a, 24b, 25a, 25b, have their wires, 20, 22, 24c, connected to the switch box and its switch, 19, 14, FIG. 4. The switch boxes, 19, 14, have electrical wire connected to the power source like the battery, 15, FIG. 4. The power source could be the wall outlet as well. The switch box, 19, 14, may contain electronics and transformer to supply the right voltage and current to the piezoelectric actuators (or reciprocating electromagnets, or solenoids), 23, 24a, 24b, 25a, 25b, FIG. 4. When the switch, 14, is turned “on,” the current will flow into the piezoelectric actuators (or reciprocating electromagnets, or solenoids), 23, 24a, 24b, 25a, 25b, which will begin to vibrate and experience vigorous motion, FIG. 4. Operation of the piezoelectric actuators in one direction, x, or y or z and have vibrations in x, or y, or z-direction. One could also have, 23, 24a, 24b, 25a, 25b, as curve-linear piezoelectric actuators (or reciprocating electromagnets, or solenoids) instead of a linear piezoelectric actuators (or reciprocating electromagnets, or solenoids) causing curve-linear reciprocating vibratory motions onto the affixed main rod, 26, and the attendant attachments 28a, 28b, 27, 29, 30, 31, FIG. 4. Upon electrification of the piezoelectric actuators (or reciprocating electromagnets or solenoids), 23, 24a, 24b, 25a, 25b, the rod piece, 26, and the configured of FIG. 4, will vibrate at some predetermined frequency and amplitude of back and forth displacement. Since the stirring system of FIG. 4 will be immersed in a container or a cup, 7, filled with some solvent (like hot water) the solutes contained within, 29, 30, 31, will robustly percolate out into the solvent to allow for a thorough and homogeneous mixture of solute and solvent to materialize, FIG. 4. Once the mixture is satisfactorily made in the container or cup, 7, the operation will be ended by the switch, 14, being turned “off” and the stirring system is taken out of the container or cup, 7, and the ring, 28a, unfastened from the ring holder, 27, to dispose away the unused solute containing bag or wafer, 29, 30, 31, FIG. 4. Then the stirring system can be reused again with another set of small food bags or food wafers, 29, 30, 31, FIG. 4.

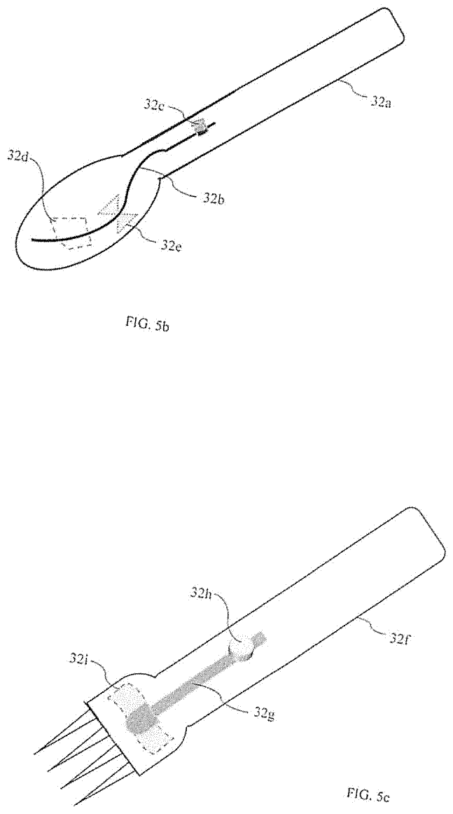

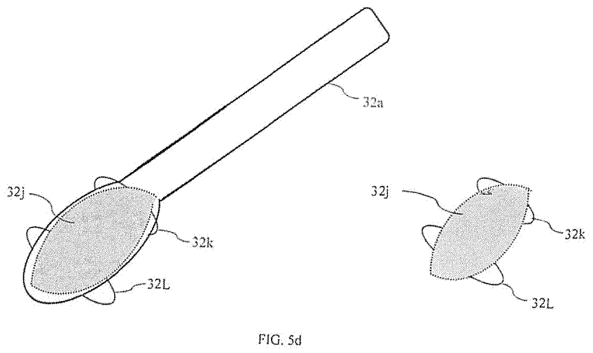

FIG. 5a discloses two different food wafers or porous food bags that are made to traverse and robustly jam and pack inside the slit holes, craved on the flat stick piece made from wood, or metal or plastic or solid food material. There can be one or more of these stirring system arranged in series and, or parallel manner, with one or more of these narrow slits, carrying and holding one or more of these food wafers or porous food bags in parallel or series fashion.

FIG. 5a represents the elements of the stirring system disclosure similar to FIG. 1, but herein, 32, is a wooden (can be made from metal, plastic, solid food) stick with a midline vertical narrow incisional slit hole, 33, through which a food wafer (or any other chemical or solid solute wafer) or small membranous porous food bag (or membranous porous chemical bag) would traverse through. In the bottom through a similar narrow vertical incisional slit hole, 33, another different food wafer (or chemical wafer), or food bag (or chemical bag), 35, would traverse through, FIG. 5a. In this case, the stirring system consists of the elements, 32, 33, 34, 35, FIG. 5a. When this stirring system of FIG. 5a, is immersed in a solvent contained within a container or cup, 7, and stirring system is manually twisted and turned by grabbing the top of, 32, then the solutes contained in the food wafers or food bag, 34, 35, will begin to dissolve its' solutes into the solvent contained within container or cup, 7, FIG. 5a. For instance immersing this tea and sugar (or coffee, or spice, or dried solid milk, or any other food substances) containing stirring system into a cup, 7, filled with hot water (or any other solvent) and twisting and turning, 32, will allow the tea and sugar (or any other food substances) to dissolve into the hot water (or any other solvent), FIG. 5a, thereby abating the need to get sugar and tea (or any other food substances) separately to make a tea mixture (or any other solute and solvent solution mixture). Note that in the stirring system the tea and sugar (or any other food substances) are calibrated in the proper amounts to a given calibrated volume amount of hot water (or any other solvent) so as to not make the product beverage less tasty or the ingredients deficient or in excess of what's desirable.

FIG. 5b discloses a spoon modified, wherein the said spoon is affixed with a thin flat piece entity or a flat spring like entity. The thin flat piece entity or the flat spring entity is made from metal, or wood, or plastic or solid food material, and can be fastened to the neck or handle of the spoon by a screw system. The flat piece entity or flat spring entity extends from the neck or handle of the spoon in close apposition to the bowl of the spoon. In between the thin flat piece entity or the thin flat spring entity and the bowl of the spoon, one or more different food wafers or porous food bags can be held in a tightly tucked away position, such that the solute containing food wafers or porous food bags does not dislodge when this stirring system spoon is used to stir the said solutes of the tucked away food wafers or porous food bags into the solvent containing cup or container. FIG. 5b represents a spoon, 32a, that contains a hard flat thin piece of metal or a thin piece of flat spring like entity, 32b, affixed by a screw, 32c, onto the stem of the spoon. The flat spring like entity, 32b, can be edible food substances. A food wafer or a food bag (or chemical wafer or chemical bag), 32e, 32d, of different shapes and sizes containing tea, coffee, honey, sugar, spices, salt, any other food substances, chemical, or biochemical can be tucked into the flat spring like entity, 32b, FIG. 5b. The food wafer or food bag, 32d, 32e, when tucked between the flat spring entity, 32c, and the spoon (bowl), 32a, will have substantive frictional force to hold the food bag or food wafer, 32e, 32d, in place and in stable position such that when the spoon so constructed is used to stir swirl and rotated into a solvent containing container like a cup, 7, the food wafer or food bag 32e, 32d, will not dislodge from the said spoon. The solutes of the food wafer or food bag, 32e, 32d, can thus be made to dissolve into the solvent of the container. For instance, food wafer or food bag, 32e, could be a tea and the food wafer or food bag, 32d, can be honey or sugar which are tucked between the flat spring entity, 32b, and the spoon (bowl), 32a, FIG. 5b. When this spoon, 32a, is placed inside a solvent like hot water cup and this spoon, 32a, is stirred and swirled then the solutes contained within the tea bag or tea wafer, 32e, and sugar bag or sugar wafer, 32d, will begin to dissolve into the hot water contained inside the cup, thus making a desired cup of tea, whence a calibrated amount of tea and sugar are mixed into a calibrated amount of solvent volume. Once the tea and sugar solution is made, the remaining bag of sugar or tea can be manually dislodged from a tucked position between 32b and 32a and disposed and discarded FIG. 5b. The stirring system spoon can be used again. The stirring system spoon can be made disposable, as well. Again this disclosure renders a compact design in which tea and sugar (and spice) are bound to the spoon via a flat spring entity, 32b, to create a desirable mixture or solution when aforesaid stirring system spoon, 5b, is used inside a solvent containing cup or container, FIG. 5b. There are many different ways that the food wafers or food bags, 32d, 32e, can be fastened on to the spoon or fork or any other kitchen utensils, to make a stirring system spoon. For instance using a thread or an elastic rubber band or wire or staples or pins or even a single screw on spoon bowl, or a hook on the spoon bowl, or a ring on the spoon bowl, all to tie the food wafer or food bag, 32d, 32e, onto the spoon, 32a,

FIG. 5c discloses a fork modified, wherein a thin flat piece entity or a thin flat spring entity made from metal or wood or plastic or solid food material is affixed or screwed onto the neck or handle of the fork. The flat thin piece entity or the thin flat spring entity lies in opposition to the neck, handle, and root of the fork. Food wafers or porous food bags are tightly tucked away in the gap between the thin piece flat entity or the thin flat spring entity and the root of the fork. There are many ways to fasten the flat piece entity or flat spring entity to the fork; for instance by a pin system that anchors the flat piece entity onto the neck or handle of the fork; or a hook on the flat piece entity going into the hole on the neck or handle of the fork; or a hook on the neck or handle of the fork going into the hole of the flat piece entity; or a hook on the flat piece entity going onto a ring on the neck or handle of the fork, and in many more ways, a flat piece entity can be secured onto the stirring system.

FIG. 5c represents a fork, 32f, instead of the spoon, 32a, of FIG. 5b, wherein, a flat piece of metal or flat spring, 32g, is affixed to the neck or handle of the fork, 32f, by a screw system or a pin system, 32h. The food bag or food wafer, 32i, is tucked tightly between the flat metal piece or flat spring, 32g, and the root of the fork, 32f, FIG. 5c. Substantial force would exist between the flat metal piece or flat spring, 32g, and the fork root, 32f, to hold the food bag or food wafer, 32i, in place and tightly tucked away position such that, 32i, will not dislodge when swirling, stirring, rotating, spinning motion of the fork, 32f, is conducted inside a solvent containing cup or container. This stirring system fork like the stirring system spoon signifies a compact device that accomplishes the task of mixing any solutes into any solvent. Indeed any kitchen utensils can be made into this configuration of the stirring system to allow food wafers or food bags, 32i, to mix into any solvent to yield a desirable solution mixture. Once the desired solution is created, then the food bag or food wafer, 32i, can be discarded and disposed of, especially if the food bag or food wafer, 32i, did not completely dissolve into the solvent with some residue remaining in the food bag. Note that the screw, 32c, of FIGS. 5b, and 32h, of FIG. 5c can be unscrewed out such that flat metal piece or flat spring piece, 33b, 32g, respectively, can be separated from the spoon or fork, 32a, 32f, so as to allow for their cleaning to happen before next use (wherein the screw,32c, 32h, will be screwed back into the spoon, 32a, or fork, 32f, fastening the flat spring or the flat metal piece, 32b, 32g, onto the stirring system spoon or stirring system fork). Moreover, during consumption of certain meals (like soups), the food bag or food wafer, 32e, 32d, on the spoon, 32a, FIG. 5b, or the food bag or food wafer, 32i, on the fork, 32f, FIG. 5c can be left in place and not discarded such that with each stirring system spoonful or stirring system forkful of food consumed yields enhanced taste, and, or, nutrition of the food mixture so consumed. Again, there are many ways to fasten the food bag or food wafer, 32d, 32e, 32i, onto the body of the spoon, 32a, or fork, 32f, or any other utensils. For instance, a food wafer or food bag that's trapped between a hook on the hard flat spring entity, 32b, or the flat piece entity, 32g, that articulates and hooks' onto a hole on the neck of the spoon, 32a, or hole on the handle of the fork, 32f, to affix and fasten the flat spring entity, 32b, or flat piece entity, 32g, onto the spoon or fork, respectively. The food wafer or food bag can also be tied by a thread to the root of the fork, or pinned to the root of the fork, or screwed by single screw onto the root of the fork, or stapled to the root of the fork. The food wafer or food bag can be glued onto the stirring system spoon or stirring system fork system as well.

FIG. 5d illustrates a different design configuration of the FIG. 5b stirring system spoon, (or any other stirring system utensil), wherein, a porous bag (made out of non-harmful filter paper for instance) containing food within itself, or a food wafer, 32j, are affixed with one or more of an elastic or non-elastic thread, 32k, 32L, like structures as shown in FIG. 5d, that may or may not encircle the food bag or food wafer, 32j. The said food bag or food wafer entity,32j, is made to slide onto a spoon, 32a, (or any other utensil) and its' elastic or non-elastic threads encircle the bowl of the spoon, 32a, (or any other utensil) so as to secure the food bag or food wafer, 32j, entity onto the spoon, 32a, (or any other utensil), FIG. 5d. In this configuration, the spoon, 32a, and the food bag or food wafer, 32j, 32k, 32L form another stirring system design construction, FIG. 5d. So, for instance, the porous food bag, 32j, can be made to contain tea. Then the stirring system, 32a, 32j, 32k, 32L, will be immersed into hot water, and this stirring system spoon can be manually stirred to allow the tea solutes to dissolve into the hot water solvent, to make the desired tea solution. Again, note that the outer layer of the food bag, 32j, can be made of benign filter paper and or any non-harmful porous bag material, or the bag itself can be made from food material, FIG. 5d. Similarly, the elastic or non-elastic threads, 32k, 32L, can be made from non-harmful material, including food material, FIG. 5d. Indeed the entire stirring system spoon, 32a, (or any stirring system utensil) in this description of the stirring system can be made of food material, FIG. 5d.

FIG. 5d discloses a food bag or a food wafer or a tea bag or a tea wafer or coffee bag or coffee wafer, which may include one or more threads or elastic threads affixed around the bag or wafer in a closed circular fashion. This food bag or food wafer or tea bag or tea wafer or coffee bag or coffee wafer entity is made to sit onto the spoon (or any other utensil) by virtue of the threads or elastic threads going around the spoon (or any other utensil), thus the bag or the wafer to be secured onto the spoon (or any other utensil). The threads can itself be made from food materials. In this configuration, the bags or wafers are secured or articulated onto a utensil like a spoon for the purposes of stirring the contents of the aforementioned food bag or wafers into the solvent contained in a cup. After one use, the system can be discarded and be disposable or used again.

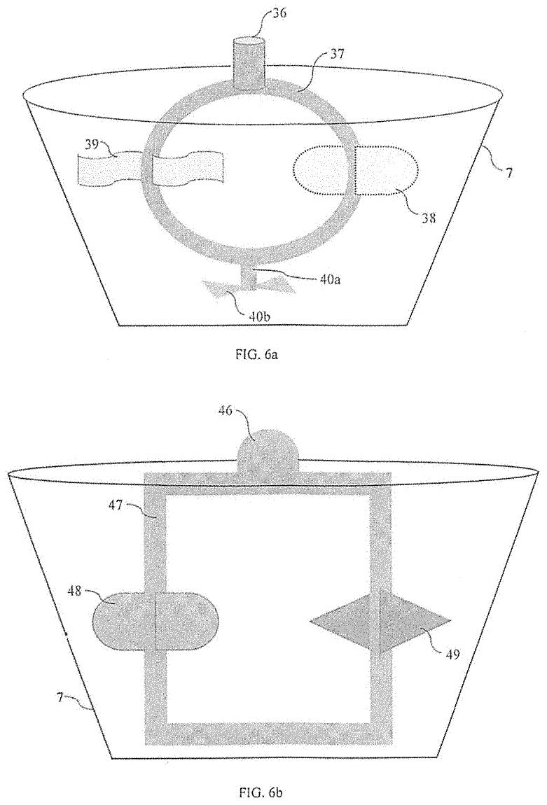

FIG. 6a discloses a circular disc-shaped configuration, wherein, one or more of the food wafers or a porous food bags are packed or jammed through a narrow slit hole on the circular disc entity or glued (with a nontoxic glue) onto the circular disc-shaped stirring system. Illustrated also is a small turbine or fan blades entity that articulates with a shaft through a set of bearings with the said shaft affixed to the circular disc-shaped stirring system (or the said shaft and its attendant turbine or fan blades can be attached to any other stirring system configuration mentioned in this entire presentation). The stirring system thus created can be immersed into a solvent containing cup or container and be made operational by stirring the said circular disc stirring system into the said solvent containing cup or container causing the solutes of the food wafers or porous food bags to dissolve into the said solvent in the cup or container.

FIG. 6a represents a different stirring system configuration from the ones' illustrated in FIG.1 through FIG. 5. Herein the new configuration is a circular, disc-shaped, 37, the stirring system, FIG. 6a. The circular disc-shaped entity, 37, can be made from metal, wood, plastic, solid food substances so as to be dissolvable or non-dissolvable. A knob handle, 36, is affixed to a circular disc, 37, FIG. 6a. The circular disc, 37, entity may include an arc like slit holes in them through which the passage of the food wafer or food bag, 39, 38, can happen so as to hold these solute food wafers or porous membranous food bags, 39, 38, tightly in place without allowing for the said food bag or said food wafers, 39, 38, to slip and dislodge from the circular disc, 37, entity especially during stirring, spinning, rotating motion of the said circular stirring system entity, FIG. 6a. At the bottom of the circular disc, 37, stirring system, there is a small fan or turbine, 40b, like attachment that freely rotates around a shaft, 40a, and supported by bearings around the shaft, 40a, FIG. 6a. This circular disc like configuration of the stirring system comprises 36, 37, 39, 38, 40b, 40a, which can be immersed in a solvent contained container or a cup, 7, and spun, rotated, twisted and turned manually by holding onto the knob holder, 36, FIG. 6a. The circular motion of the disc, 37, and the fan/propeller/turbine blade like structure, 40a, will allow for augmented motion of the solvent in the cup, 7, to make the solutes of the food bag or food wafers 39, 38, to dissolve expeditiously, making a desired solution mixture, FIG. 6a. The actuators in FIG. 3 and FIG. 4 could also be used to stir, spin, rotate, swirl, twist, and turn the stirring system configuration of FIG. 6a. This configuration of the stirring system may allow for efficient, less time consuming expeditious, homogeneous mixing of solute and solvent to happen rendering a better tasting beverage or the desired chemical or biochemical solutions. Additionally, the presence of the fan/propeller/turbine blades in this configuration of the stirring system will allow for industrial application for mixing solutes and solvents.

FIG. 6b discloses a rectangular configuration of the system of FIG. 1, wherein, the food wafers or the porous food bags are glued (by a non-toxic food glue material), or packed or jammed in between the narrow slit holes on the walls of the said rectangular shaped stirring system entity. Thus created can be immersed into a solvent containing cup or container and made operational by stirring the said rectangular stirring system entity into the said solvent of the cup or container, enabling the solutes of the food wafers or porous food bags to dissolve into the said solvent of the cup or container.

Similarly, FIG. 6b shows a rectangular shaped stirring system entity comprising of the manual knob handle, 46, affixed to the rectangular stick configuration, 47, which have embedded within them the food wafers or membranous porous food bags, 48, 49, with different shapes and sizes, all of which can be immersed inside a solvent containing container or cup, 7. The rectangular shaped stirring system entity, 47, can be made from metal, wood, plastic, solid food substances itself so as to be dissolvable or non-dissolvable. When the manual knob handle, 46, is stirred, swirled, spun, rotated, twisted and turned, manually then this rectangular configuration of the stirring system will allow the solutes of the embedded food bags or food wafers, 48, 49, to dissolve into the solvent contained in the container or cup, 7, FIG. 6b. Again the actuators of FIG. 3 and FIG. 4 can be used to twist and turn the manual knob handle, 46, allowing for the homogeneous mixture of the food solutes from the food wafers or porous food bags, 48, 49, to dissolve into the solvent like water to occur expeditiously and in a less time consuming manner. This rectangular design of the stirring system, FIG, 6b, may offer a cost effective design over the circular disc stirring system configuration, FIG. 6a. Therefore so many design configuration possibilities exist for the stirring system to meet the different purposes of making distinct solute and solvent mixtures.

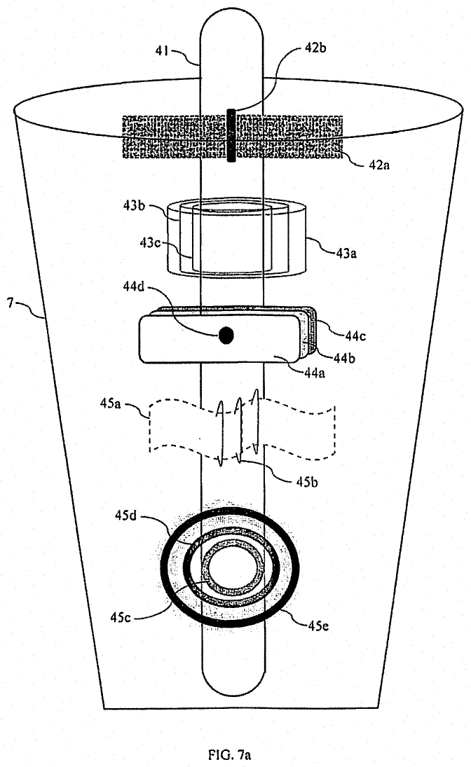

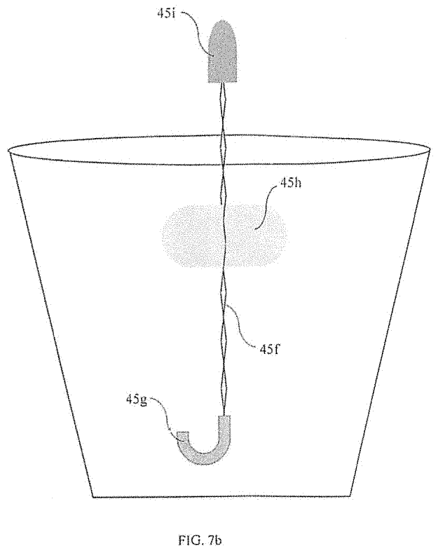

FIG. 7a discloses a cross shaped configuration wherein the food wafers and, or the porous bags containing food material, have one or more layers of different food substances, in a cylindrical layered configuration, or a spherical layered configuration, or a box layered configuration, or a cuboid layered configuration. These configurations of food wafers or porous food bags can be affixed to the stirring system stick entity by a staple or by a metal wire or by a thread or by a pin or by a screw, or by glue. The stirring system thus created can be immersed into a cup or a container containing a solvent and made operational by stirring the stirring system entity into the said solvent in the cup or the container for the purposes of dissolving the solutes in the food wafers or porous food bags into the said solvent of the cup or the container.

FIG. 7a represents another embodiment of the stirring system entity wherein various configuration and designs of the food wafers or small membranous porous food bags that are affixed to the stick piece, 61, are illustrated. The stick-like piece, 61, can be made from wood, or metal, or plastic, or stone, or, solid food substance or any other material, rendering, 61, dissolvable or non-dissolvable. The entity, 42a, represents a rectangular shaped food wafer or porous food bag that's' embedded or glued onto the stick, 61, or affixed or tied to the stick, 61, by other means like one or more metal staples, or one or more metal pins, or one or more metal wires, 42b, FIG. 7a. Illustrated, next, are these concentric cylindrical type food wafers, 43a, 43b, 43c, which are three different layers of food substances (could be chemical or biochemical substances as well) on top of the other and wrapped around each other and to the central stick, 41, FIGS. 7a and 44a, 44b, 44c, representing rectangular pieces of three different layers of food substances (could be chemical or biochemical as well) all glued to each other and to the main stick, 41, FIG. 7a. The rectangular layered food wafer (or porous food bag), 44a, 44b, 44c, can also be pinned or screwed by a screw, 44d, onto the stick, 41, FIG. 7a. Next, the entity, 45a, represents food bag or food wafer embedded from one side to the other side of the stick, 41, and tied by the threads, 45b, into the stick, 41, FIG. 7a. Last but not least, 45c, 45d, 45e, represents a circular and, or spherical piece of three different layers of food substances stuck on top of one another in a fashion shown in FIG. 7a, allowing for the layering of different food substances on top of another. Immersing this configuration of the stirring system entity, as illustrated in FIG. 7a, into a solvent contained container or a cup, 7, and stirring, spinning, rotating, twisting and turning, 41, and the said stirring system assembly will allow the proper mixture of the solutes inside the porous food bag or food wafer, 42a, 43a, 43b, 43c, 44a, 44b, 44c, 45a, 45c, 45d, 45e, into the said solvent contained inside the container or cup, 7, FIG. 7a.

FIG. 7b discloses two or more somewhat pliable hard wires (made from metal, wood, plastic, or solid food substances) are twisted together around each other into a double helix, spiral conformation. The porous food bags or food wafers are affixed or lodged or glued into the said spirally intertwined wires. There is a holder on top and a J shaped entity at the bottom of the said, stirring system entity to help with the stirring operation. The stirring system so created can be made operational by stirring the stirring system entity into a cup or a container containing a solvent in order to dissolve the solutes of the food wafers or porous food bags and or the twisted wire entity, into the solvent of a cup or a container in order to create a desired solution mixture.

FIG. 7b illustrates two relatively hard wires, 45f, (made of metal, wood, food substance, plastic) that are intertwined into each other, and interwoven with one or more porous food bag or food wafer, 45h. The porous food bag or food wafer, 45h, can be glued into the said thin piece of intertwined hard wire pieces, 45f, FIG. 7b. A knob holder, 45i, and a J-shaped stirrer entity, 45g, are also affixed to the stirring system, FIG. 7b. The stirring system can be immersed into a solvent containing container or cup, 7, and swirled, spun, rotated, twisted, turned to make the solutes of the food bag or food wafer, 45e, to dissolve into the said solvent, FIG. 7b. Thus, the stirring system can be made disposable and for single use, FIG. 7b.

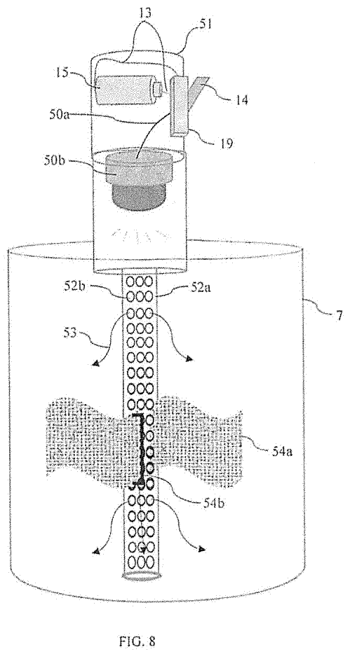

FIG. 8 discloses a tube with multiple holes on itself with one or more slit holes across its surface through which food wafers or porous food bags can be lodged and, or be embedded. Alternatively, the food wafers or porous food bags can be glued (with a non-toxic glue) onto the said multi hole porous tube. (The said tube need not have holes or slits or be porous at all.) Electromagnetic waves like ultraviolet light, microwaves, visible light waves, radiant heat waves, are made to come out through the porous holes of the said tube. The source of these electromagnetic waves emanating through the porous multi hole tube can be a lamp or any other form of electromagnetic wave generator which is affixed to an encasing, which in turn is affixed to the said multi hole tube. The lamp or an electromagnetic wave generator is to be electrically connected to a power source like a battery or to an electrical wall outlet. The inner surface wall and or the outer surface wall of the said tube and, or the electromagnetic wave generator encasing and or the electromagnetic lamp encasing, can be coated with an electromagnetic reflective coating material. The reflective coating within the tube and the encasing will aid the electromagnetic waves to exit out of the stirring system and interact with the solute and, or solvent solution mixture. Thus this stirring system so created is to be immersed into a solvent containing cup or container and made operational by stirring this stirring system entity into the said solvent contained container, making the solutes of the food wafers and or porous food bags on this stirring system to mix into each other and interact with electromagnetic waves at the same time to create a desired solution mixture.

FIG. 8 shows another embodiment of the stirring system, wherein there is a tube, 52a, which may have very fine numerous holes, 52b, on its body, and is affixed to an encasing, 51. The tube with numerous holes, 52a, 52b, also may include a slit, 54b, through which a food wafer or a porous food bag, 54a, can be translocated such that the food wafer or food bag, 54a, is jammed and packed in a tightly tucked away position making difficult for the porous food bag or food wafer, 54a, to dislodge especially during stirring, swirling, spinning, rotational, motion of the aforesaid stirring system, FIG. 8. The stirring system further comprises 52a, 52b, 54a, 54b, 51, 50b, 15, 14, 19, FIG. 8. Inside the encasing, 51, resides an affixed Lamp, 50b, which generates electromagnetic waves, like ultraviolet waves that kill bacteria and other germs, FIG. 8. The lamp, 50b, could also generate other electromagnetic waves like visible light, radio waves, lasers, masers, heat, and radiant waves, FIG. 8. The inner wall of the encasing, 51, and the inner wall of numerous hole tube, 52a, can be coated with an electromagnetic wave reflective material that allows the electromagnetic waves to travel from the lamp, 50b, down into the multi hole tube, 52a, and exit out of through those tube holes, 52b, as an electromagnetic wave, 53, into the solvent (possible hot, or possible cold) and solute (emanating out of the porous food bag or food wafer, 54a), mixture, FIG. 8. The switch, 14, the switch box, 19, a battery, 15, (or any other power source like a wall outlet) are connected by the wires, 13, 50a, to the electromagnetic wave generator source, 50b, FIG. 8. So when a solvent is poured into a container or glass or cup, 7, then the stirring system comprising of the joined elements, 13, 15, 14, 19, 50a, 50b, 51, 52a, 52b, 54a, 54b, is immersed into the aforesaid solvent contained in a container or glass or cup, 7, then the stirring system is swirled, rotated and moved to allow the solutes, especially of the food wafer or porous food bag elements, 54a, to dissolve into the said solvent to be happening in the presence of the an electromagnetic waves or Ultraviolet light, shower when the switch, 14, is turned “on,” FIG. 8. For instance, the food wafer or porous food bag, 54a, could be a tea wafer or tea bag or coffee wafer or coffee bag, and the solvent in the cup or glass, 7, could be hot water, and lamp, 50b, an Ultraviolet lamp light source, wherefore this stirring system of tea or coffee wafer, UV light are stirred into the hot water solvent creates a germ free desired tea or coffee beverage solution mixture, FIG. 8. Similarly, the function of optically active molecules could be enhanced in the solution mixture in the use of this configuration of thr stirring system if a visible light lamp, 50b, is used instead of a UV light lamp, FIG. 8.

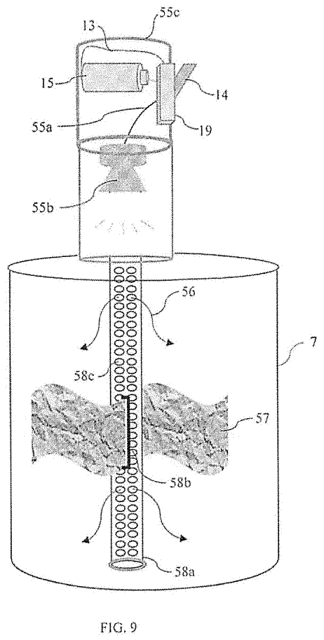

FIG. 9 discloses a porous multi hole tube or a plain tube with slits through its surface are made to hold disposable porous food bags and or dissolvable food wafers. The dissolvable food wafers are made to completely dissolve into a solvent when the food wafers are stirred into the solvent. Alternatively, the food wafer or porous food bag can be glued (with a nontoxic glue, for instance) onto the wall of the multi hole porous tube or into the slits' of the said tube. Affixed on top of the multi hole porous tube is an encasing inside which resides an affixed sound wave generator device like a speaker that is electrically connected to a switch box which in turn is electrically connected to a power source like a battery. Contained inside the switch box is any number of audio player devices that feeds sound electrical signals into the sound generator device or speaker unit. From the speaker, the generated sound wave passes out through the holes of the said multi hole porous tube. The inner wall and or the outer wall of the said tube could be covered with a sound reflective coating material. This stirring system so created is to be immersed into a cup or a container containing a solvent and made operational by stirring and allowing the sound waves, the solutes (food or chemical), and the said solvent to mix into each other and create a desired solution mixture.

FIG. 9, having similar configuration as FIG. 8, however, instead of an electromagnetic wave generator lamp source, 50b, there is a sound producing generator or a Loudspeaker, 55b, in its place. The sound producing generator or a speaker, 55b, is affixed to an encasing, 55c, and it is electrically connected through the wires, 55a, to the switch box, 19, and the switch 14, which in turn is connected to an electrical power source like a battery, 15, via the wires 13, FIG. 9. Inside the switch, box resides any conventional sound player device or small conventional music player device that will electrically feed signals into the speaker, 55b, FIG. 9. The encasing, 55c, is affixed to a tube, 58a, which may include multiple fine holes, 58c, in its walls, FIG. 9. The inner walls of the encasing, 55c, and the multi-hole tube, 58a, are coated with sound reflective material, FIG. 9. The food wafer or porous food bag, 57, is made to slide into the slit, 58b, carved into the multi-hole tube, 58a, FIG. 9. The food wafer or porous food bag, 57, is lodged into the narrow slit, 58b, such that the frictional forces between the porous food bag or food wafer, 57, and the slit, 58a, of the multi-hole tube, 58a, is high so as to prevent the dislodging of the food wafer or porous food bag, 57, out of the slit, 58b, when the stirring system comprising of, 58a, 58b, 58c, 57, 55a, 55b, 55c, 19, 14, 15, 13, are stirred, moved, rotated, spun into a solvent containing cup, or glass, 7, FIG. 9. When the switch, 14, is turned “on,” and the stirring system illustrated in FIG. 9 is immersed into the solvent containing container or cup or glass, 7, and the said, stirring system is manually, swirled, stirred, moved, and rotated, or the actuators of FIG. 4 and FIG. 3 are used to move this stirring system, then, the sound waves emanating from the speaker or sound generator, 55b, help mix the solute emanating out of the porous food bag or food wafer, 57, into the solvent in expeditious manner, FIG. 9. The mixture of sound waves with food solutes from the food wafer or porous food bags mixing into a solvent may yield a desirable solution and beverage mixture. For example, a ribbon of a tea wafer or tea bag, 57, swirled and mixed in with hot water solvent in cup, 7, together with a sound waves or music waves, 56, emanating out from the multi-hole tube, 58a, may create a different desirable homogeneous mixture of a tea solution, FIG. 9. Note that the food wafer, 57, is designed to melt away and relinquish its solutes into the solvent containing container or cup and may not leave any residue behind. Additionally, there can more than one slit like entity, 58b, and more than one porous food bags or food wafers, 57, into the configuration of the stirring system so described, FIG. 9. For example, a tea wafer, 57, in on one slit can be accompanied by a sugar wafer on another slit and or spice wafer on another slit and or a solid milk wafer still on another slit all contained on the tube, 58a, configuration of the stirring system described in FIG. 9. It needn't be that a slit hole, 58b, can hold a food wafer or porous food bag, 57, onto the tube, 58a, indeed the food bag or food wafer, 57, can be glued, tied with wires or threads, stapled, pinned, screwed, into the multi-hole tube, 58a, in many different ways, FIG. 9.

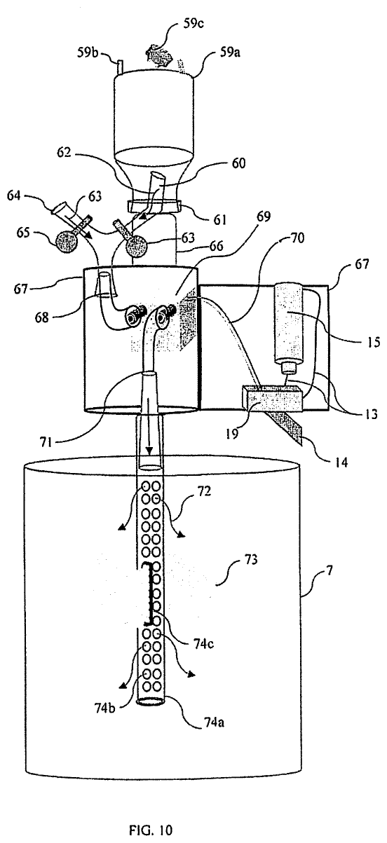

FIG. 10 discloses a tube or a multi hole porous tube with a hollow slit through its surface (like FIG. 8 and FIG.9), tightly holds a porous food bag or a food wafer or a membranous bag containing chemicals or a wafer containing chemicals. Air, Gas (like oxygen, carbon dioxide, nitrogen, etc.) or any other solution or both (gas and solution), can be pumped via a pump (such as a diaphragm pump) out through the porous multi hole tube. A tube conducting air and or gas into the pump is interrupted with a valve that regulates the flow of gases into the pump, and a tube connected to an inverted bottle containing a different solution (from the cup solvent) is also interrupted with a valve to control the flow of the said different solution into the pump. The inverted bottle containing a different solution is affixed outside and on top of the pump encasing. The pump is securely affixed to the inner wall of the pump encasing. Inside the pump encasing a power source like a battery is electrically connected to the switch box and a switch, which electrically connects to the pump. This stirring system so created can be immersed into a solvent containing cup or container and made operational by the stirring motion of the this stirring system entity and simultaneously activating the pump causing the pumping of the gases and or a different solution into the said solvent containing cup or container in order to mix in with the stirred (food or chemical) solutes from the said bag or said wafer, blended together to create the desired solution mixture.

FIG. 10 having similar configuration as FIGS. 8 and 9, however, instead of an electromagnetic wave generator source, 50b, or a sound wave generator source, 55b, a pump, 69, is put in its place. The pump, 69, can propel air or gas through the tube, 64, or another solvent from the bottle or container, 59a, into the pump's inflow tract tube, 68; then the air or gas or another solvent is pumped into the outflow tract tube, 71, into the multi-hole tube, 74a, to exit and flow out of the holes, 74b, in order to mix in with the already present solvent in the container or cup or glass, 7, FIG. 10. The pump, 69, inflow tract tube, 68, bifurcates into the tube, 64, with an intervening valve, 65, on one side and then it's connected to tube, 60, with an intervening valve, 63, on the other side FIG. 10. The tube, 60, resides inside a container or a bottle, 59a, by going through a tightly sealed hole on the bottle cap, 61, such that any solvent or food solvent or food solution or chemical or biochemical, does not leak or escape from around the tube, 60, when it is affixed to the bottle cap, 61, FIG. 10. On top of the bottle, 59a, there is a small affixed tube, 59b that conducts atmospheric air into the bottle, 59a, FIG. 10. Also affixed to the top of the bottle, 59a is an articulating screw cap, 59c, which will screw into the bottle once a solvent or a solution is poured into the bottle, 59a, FIG. 10. The bottle, 59a, is securely affixed to a board, 66, which in turn is affixed to the encasing, 67, FIG. 10. The pump, 69, is affixed to the inner wall of the encasing, 67, FIG. 10. The pump, 69, outflow tract tube, 71, connects and is affixed to the multi-hole tube, 74a, FIG. 10. Note that tube, 74a, in FIG. 10 and the tubes, 52a, 58a, illustrated in FIG. 8, and FIG. 9, can be made of metal, wood, plastic, including solid food material that is dissolvable or non-dissolvable. As stated before, the stirring system can be made from metal, wood, plastic, food material (dissolvable or non-dissolvable), or even stone. As before, the multi-hole tube, 74a, may include a slit hole, 74c, through which a food wafer or a porous food bag, 73, is translocated, FIG. 10. The food wafer, or porous food bag, 73, will have dissolvable food material that will give out its solutes to dissolve into the solvent pre-present in the container or cup, 7, FIG. 10. The pump, 69, is electrically connected via wires, 70, to the switch box, 19, 14, which in turn is electrically connected via wire, 13, to an electrical power source like the battery, 15, as in, FIG. 10. Note that the power source, 15, and the switch box and the switch, 19, 14, are affixed to the inner wall of the encasing, 67, FIG. 10. So when the switch, 14, is turned “on,” then electricity flows from the power source, 15, into the pump, 69, via the switch box, 19, FIG. 10. The pump, 69, (in this case is a small diaphragm pump), that sucks air or gas through the inflow tract tube, 64, and then through the intake valve, 65, when it is open, then into main intake tract tube, 68, and then into the pump, 69, and finally pumped out through the main output tube, 71, FIG. 10. The main output tube, 71, conducts the air or gas flow into the multi-hole tube, 74a, FIG. 10. The air or gas flow, 72, out of the tube holes, 74b, and mixes with the solvent contained within the container or cup, 7, FIG. 10. The solutes of the food wafer or porous food bag, 73, would percolate and dissolve into the solvent contained inside the container or cup, 7, FIG. 10, when the stirring system of FIG. 10, is stirred, spun and rotated inside the said solvent containing container or cup, 7. This descriptive account of the stirring system further comprises, 74a, 74b, 74c, 73, 72, 71, 69, 19, 14, 15, 68, 66, 65, 63, 64, 61, 60, 59a, 59b, 59c, that can be swirled, stirred, spun, rotated, around the solvent containing container or cup, 7, FIG. 10, again to make the solutes of the food wafer or porous food bag, 73, to dissolve into the solvent contained in the container or cup, 7, FIG. 10. So in this operational configuration of the stirring system entity air or gas like oxygen, can be made to dissolve into the solvent contained in the container or cup, 7, together with the solutes from food wafer or porous food bag, 73, that dissolves expeditiously into the solvent contained in the container or cup, 7, FIG. 10. Henceforth creating a gas or air, solute, solvent solution mixture which may be desirable liquid or desirable drinkable consumable beverage in the container or cup, 7, FIG. 10. Once the beverage is made, the switch, 14, is turned “off” and the food wafer or the residual porous food bag, 73, if it did not dissolve completely, can be removed from the slit, 74c, and discarded and disposed of, FIG. 10.

Now if the valve, 65, is closed and valve, 63, is opened then the solvent or small food particle solute inside the bottle, 59a, will be sucked through the tube, 60, into the main intake tube, 68, when the switch, 14, is turned “on,” and electrical energy is flowed into the pump, 69, through the electrical power source, 15, FIG. 10. From intake tube, 68, the food solution, or food solvent, or small particle food solutes will be pumped out through the output flow tract tube, 71, into tube, 74a, and eventually pumped out through its multi-holes, 74b, to mix into the solvent of the container or cup, 7, FIG. 10. Concurrently, the porous food bag or food wafer, 73, will dissolve out its solutes as the entire stirring system, 74a, 74b, 74c, 73, 71, 69, 19, 14, 15, 68, 66, 65, 63, 64, 61, 60, 59a, 59b, 59c, is made for swirling, stirred, rotated around the solvent containing container or cup, 7, FIG. 10. Hence the solvent or small particle solute from the bottle, 59a, will be pumped into the solvent contained inside the container or cup, 7, together with the solutes from the porous food bag or food wafer, 73, to create the desired solution mixture or desired drink, FIG. 10. Note that the screw cap, 59c, on top can be opened and closed when a solvent or small particle solute is to be re-poured into the bottle, 59a, FIG. 10. A small tube opening, 59b, permits atmospheric air pressure to enter the solvent containing bottle, 59, making possible the expeditious emptying of the solvent containing bottle, 59a, especially when the pump, 69, is turned “on,” and the valve 63, is opened, FIG. 10.

Note that the items 4, 6, 4a, 4b, 26, 28a, 32, 32a, 32f, 37, 40b, 41, 45f, 45g, 47, 52a, 58a, 74a, from FIG. 1 to FIG.10, can be made from solid food material and or solid food dissolvable material. These similar items 4, 6, 4a, 4b, 26, 28a, 32, 32a, 32f, 37, 40b, 41, 45f, 45g, 47, 52a, 58a, 74a, from the figures, can be made from iron, or steel, or, wood (that's safe for human and animal consumption), or from plastic, which are abundant material present in the environment. It's also possible, 4, 6, 4a, 4b, 26, 28a, 32, 32a, 32f, 37, 40b, 41, 45f, 45g, 47, 52a, 58a, 74a, from the figures, can be made from frozen ice water that will dissolve when mixed with any other solvent in a container or cup together with the solutes from the food wafer or porous food bag, (although the solutes of the food bag will dissolve in a solvent, but the food bag residue may remain behind to be discarded after use). The Stirring Delivery System is designed to create, expeditiously, comprehensively, and efficiently, the desirable solution mixture for human consumption, scientific experimentations, and, or industrial applications.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference, numerals may refer to similar or identical elements throughout the description of the figures.

The phrases “in an example,” “in examples,” “in some examples,” “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C.

What is claimed is:

1. A stirring system comprising:
a cup configured to hold fluids;
a lid having a top portion and a bottom portion, the lid configured to couple cover an open portion of the cup;
a stir including a knob, a longitudinal shaft, and a distal shaft extending outwardly from the longitudinal shaft, wherein the knob is disposed on the top portion of the lid and coupled to the longitudinal shaft threaded through the bottom portion of the lid; and
one or more bags coupled along the length of the longitudinal shaft.

2. The stirring system of claim 1, wherein the one or more bags is a membranous porous bag.

3. The stirring system of claim 1, wherein the one or more bags contain at least one of tea, food, and sugar.

4. The stirring system of claim 1, wherein the longitudinal shaft and the distal shaft is wood or metal.

5. The stirring system of claim 1, wherein the lid further includes a serrated portion configured to provide an opening in the lid.
